(19) United States
(12) Patent Application Publication
(10) Pub. No.: US 2026/0072937 A1
(43) Pub. Date: Mar. 12, 2026

(54) SEARCH METHOD AND APPARATUS, AND COMPUTER DEVICE AND STORAGE MEDIUM

(71) Applicant: Beijing Zitiao Network Technology Co., Ltd., Beijing (CN)

(72) Inventors: Yuqi ZOU, Beijing (CN); Ting GE, Beijing (CN)

(21) Appl. No.: 19/103,813

(22) PCT Filed: Apr. 25, 2024
(86) PCT No.: PCT/CN2024/089782

§ 371 Date: Feb. 13, 2025

(30) Foreign Application Priority Data
May 6, 2023 (CN) 202310504804.4

(51) Int. Cl. G06F 16/26; G06F 16/29; G06Q 50/14

(52) U.S. Cl. CPC G06F 16/26; G06F 16/29; G06Q 50/14

(57) ABSTRACT

A search method and apparatus, a computer device and a storage medium are provided. The method includes: acquiring a plurality of service screening labels related to a travel service in response to receiving search information which indicates searching for the travel service, wherein the travel service is related to a geographical location, the service screening label is dynamically determined according to a location feature of the geographical location, and different service screening labels are determined for different geographical locations; and-displaying the plurality of service screening labels and service search results under a currently selected service screening label.

The present application claims priority to Chinese Patent Application No. 202310504804.4 filed on May 6, 2023, the disclosure of which is incorporated herein by reference in its entirety as part of the present application.

### TECHNICAL FIELD

Embodiments of the present disclosure relate to a search method and apparatus, a computer device and a storage medium.

### BACKGROUND

With the rapid development of the tourism industry, more and more users have demands for traveling. In order to enhance the travel experience, users can usually learn about the tourism services of the destination in advance through the network to make a suitable travel strategy. For example, by learning about the services such as scenic spots, delicacies, hotels, etc. at the destination, the travel route and accommodation location are determined, etc.

However, when making recommendations based on search information entered by users, conventional search engines often have problems of low search efficiency and poor page recommendation effects, and cannot well meet the search needs of users.

### SUMMARY

At least a search method and apparatus, a computer device and a storage medium are provided in embodiments of the present disclosure.

In a first aspect, an embodiment of the present disclosure provides a search method, including:
acquiring a plurality of service screening labels related to a travel service in response to receiving search information which indicates searching for the travel service related to a geographical location, where the service screening label is dynamically determined according to a location feature of the geographical location, and different service screening labels are determined for different geographical locations; and
displaying the plurality of service screening labels and service search results under a currently selected service screening label.

In a possible implementation, the displaying the service search results under the currently selected service screening label includes:
displaying first service search results under a currently selected first service screening label;
acquiring consumption data of the first service search results corresponding to the first service screening label; and
switching to display second service search results under a second service screening label in response to the second service screening label being selected, wherein a display priority of each of the second service search results is associated with the consumption data of the first service search results.

In a possible implementation, switching to display the second service search results under the second service screening label in response to the second service screening label being selected includes:
acquiring a distance between a position corresponding to each of the second service search results and a position corresponding to a target first service search result in response to the second service screening label being selected, wherein the target first service search result is determined according to a browsing duration and a number of browsing times indicated by the consumption data of the first service search results; and
switching to display the second service search results under the second service screening label and displaying, in a display region of each of the second service search results, the distance corresponding to the each of the second service search results, wherein the display priority is determined according to the distance and a rating of the each of the second service search results.

In a possible implementation, displaying the service search results under the currently selected service screening label includes:
displaying aggregated service information under the currently selected service screening label, wherein the aggregated service information comprises a plurality of service recommendation sets, and each of the plurality of service recommendation sets comprises a plurality of service search results which are from a plurality of service channels and correspond to a same entity object.

In a possible implementation, the service screening label includes a first-level service screening label and a second-level service screening label associated with the first-level service screening label;
where acquiring the plurality of service screening labels related to the travel service includes:
acquiring a plurality of first-level service screening labels related to the travel service and a plurality of second-level service screening labels under each of the plurality of first-level service screening labels, wherein the first-level service screening label is dynamically determined according to the location feature of the geographical location, and the second-level service screening label is used to screen service search results under the first-level service screening label, and the second-level service screening label is determined according to dimensional attributes of the service search results under the first-level service screening label in different dimensions; and
where displaying the plurality of service screening labels and the service search results under the currently selected service screening label includes:
displaying the plurality of first-level service screening labels and target second-level service screening labels under a currently selected first-level service screening label; and
displaying service search results under a currently selected target second-level service screening label.

In a possible implementation, displaying the aggregated service information under the currently selected service screening label includes:
displaying each of the plurality of service recommendation sets under the currently selected service screening label according to a first recommendation order of each of the plurality of service recommendation sets in the aggregated service information; and displaying the service search results in each of the plurality of service recommendation sets according to a second recommendation order of each of the service search results in the each of the plurality of service recommendation sets;
where the first recommendation order is determined according to an object recommendation index of the entity object corresponding to the service search results in the each of the plurality of service recommendation sets; and the second recommendation order is determined according to a ranking weight of the corresponding service channel of each of the service search results and the object recommendation index of the entity object corresponding to the each of the service search results.

In a possible implementation, displaying the service search results under the currently selected service screening label includes:
displaying the service search results under the currently selected service screening label and displaying, at a preset position in a display region of each of the service search results, a recommendation reason corresponding to the each of the service search result.

In a second aspect, an embodiment of the present disclosure further provides a search apparatus, including:
an acquiring module, configured to acquire a plurality of service screening labels related to a travel service in response to receiving search information which indicates searching for the travel service related to a geographical location, where the service screening label is dynamically determined according to a location feature of the geographical location, and different service screening labels are determined for different geographical locations; and
a displaying module, configured to display the plurality of service screening labels and service search results under a currently selected service screening label.

In a third aspect, an optional implementation of the present disclosure further provides a computer device, including a processor, and a memory, where the memory stores machine-readable instructions executable by the processor, and the processor is configured to execute the machine-readable instructions stored in the memory, and the machine-readable instructions, when executed by the processor, are configured to cause the processer to perform the steps in the first aspect or any possible implementation of the first aspect.

In a fourth aspect, an optional implementation of the present disclosure further provides a computer-readable storage medium storing a computer program, where the computer program, when run by a computer device, is configured to cause the computer device to perform the steps in the first aspect or any possible implementation of the first aspect.

### BRIEF DESCRIPTION OF DRAWINGS

In order to more clearly illustrate the technical solutions of the embodiments of the present disclosure, the drawings necessary for the embodiments will be briefly described below. The drawings that are incorporated into and constitute a part of this specification illustrate embodiments consistent with the present disclosure and, together with the specification, are used to explain the technical solutions of the present disclosure. It should be understood that the following drawings only illustrate some embodiments of the present disclosure, and therefore should not be considered as limiting the scope, and for those of ordinary skill in the art, other related drawings can be obtained according to these drawings without creative effort.

FIG. 1 illustrates a flowchart of a search method provided by an embodiment of the present disclosure;

FIG. 2 illustrates a schematic diagram of a search result page provided by an embodiment of the present disclosure;

FIG. 3 illustrates a schematic diagram of displaying a second-level service screening label provided by an embodiment of the present disclosure;

FIG. 4 illustrates a schematic diagram of switching to display second service search results provided by an embodiment of the present disclosure;

FIG. 5 illustrates a schematic diagram of another service search result provided by an embodiment of the present disclosure;

FIG. 6 illustrates a schematic diagram of a search apparatus provided by an embodiment of the present disclosure; and

FIG. 7 illustrates a schematic diagram of a structure of a computer device provided by an embodiment of the present disclosure.

### DETAILED DESCRIPTION

In order to make the objectives, technical solutions and advantages of the embodiments of the present disclosure clearer, the technical solutions in the embodiments of the present disclosure will be described clearly and completely in conjunction with the drawings in the embodiments of the present disclosure. Apparently, the described embodiments are merely a part of the embodiments of the present disclosure, rather than all of the embodiments. The components of the embodiments of the present disclosure generally described and illustrated herein may be arranged and designed in a variety of different configurations. Therefore, the following detailed description of the embodiments of the present disclosure is not intended to limit the scope of the claimed disclosure, but merely represents selected embodiments of the present disclosure. Based on the embodiments of the present disclosure, all other embodiments obtained by those of ordinary skill in the art without creative effort shall fall within the protection scope of the present disclosure.

In addition, the terms “first” and “second” and the like in the description of the embodiments, the claims, and the above-mentioned drawings of the present disclosure are used to distinguish similar objects, and are not necessarily used to describe a specific order or sequence. It should be understood that data used in this way can be interchanged under appropriate circumstances, so that the embodiments described herein can be implemented in a sequence other than those illustrated or described herein.

The term “a plurality of” or “several” referred to herein means two or more. “And/or” describes an association relationship of associated objects and indicates that there may be three relationships, for example, A and/or B, which may represent three cases where A exists alone, A and B exist at the same time, and B exists alone. The character “/” generally indicates that the associated objects before and after are in an “or”relationship.

It has been found through research that when making recommendations based on search information entered by users, the service screening labels determined by conventional search engines usually are fixed. In the case of searching for travel services at different geographical locations, the service screening labels obtained in each search are often the same, which is not only poor in flexibility, but also often unable to accurately screen out the service search results needed by users. This not only affects the page recommendation effect, but also fails to well meet the search needs of users.

Based on the above research, the present disclosure provides a search method and apparatus, a computer device and a storage medium. Since different geographical locations often have different location features, and different location features can reflect the highlight information of the geographical location, in the case of searching for a travel service related to a geographical location, the location feature of the geographical location in the search information is used to determine the service screening label, which can not only dynamically determine the service screening label for different geographical locations, but also enable the determined service screening label to better show and fit the highlight information of the geographical location, thereby improving the rationality and accuracy of the determined service screening label. By displaying the dynamically determined service screening label, the flexibility of display of the service screening label can be improved; and then by displaying the service search results under the currently selected service screening label, the reasonable recommendation of the service search results can be realized, and the service recommendation effect can be improved.

Regarding the defects of the above solutions, all of them are results obtained by the inventors after practice and careful study. Therefore, the discovery process of the above problems and the solutions to the above problems proposed by the present disclosure below should be the contributions of the inventors to the present disclosure in the process of the present disclosure.

It should be noted that similar reference numerals and letters represent similar items in the following drawings, and therefore, once an item is defined in a drawing, it is not necessary to further define and explain it in subsequent drawings.

It can be understood that before using the technical solutions disclosed in the embodiments of the present disclosure, users should be informed of and authorization from users should be acquired for the type, scope of use, usage scenario, etc. of the personal information involved in the present disclosure in an appropriate manner in accordance with relevant laws and regulations.

In order to facilitate the understanding of the present embodiment, a search method disclosed in an embodiment of the present disclosure will be introduced in detail. The execution body of the search method provided in the embodiment of the present disclosure is generally a terminal device or other processing device with a certain computing power, where the terminal device may be a user equipment (UE), a mobile device, a user terminal, a terminal, a personal digital assistant device (PDA), a handheld device, a computer device, etc. In some possible implementations, the search method may be implemented by a processor calling computer-readable instructions stored in a memory.

The search method provided by the embodiment of the present disclosure will be described below with reference to the case where a computer device is used as an execution body, by way of example.

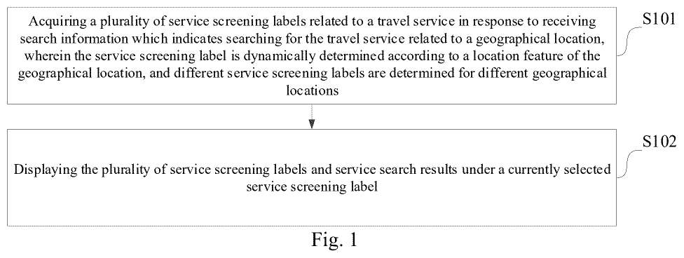

As shown in FIG. 1, which is a flowchart of a search method provided by an embodiment of the present disclosure, the following steps may be included:

S101, acquiring a plurality of service screening labels related to a travel service in response to receiving search information which indicates searching for the travel service, where the travel service is related to a geographical location, the service screening label is dynamically determined according to a location feature of the geographical location, and different service screening labels are determined for different geographical locations.

Here, the search information may be information with any length entered by the user, which may include information related to any travel service at any geographical location. The geographical location may be location information, for example, XX city, XX region, etc., and the travel service is used to provide travel-related services, such as scenic spot search and booking, hotel search and booking, delicacies search, transportation service, distinctive feature information search, etc.

Exemplarily, the search information may be scenic spots in XX city, delicacies in XX city, travel in XX region, etc.

The service search result may be a search result related to the travel service, for example, a delicacy search result, a hotel search result, a scenic spot search result, etc. The service screening label is used to screen out various service search results matched with the search information, and different service screening labels are used to screen out service search results with different attributes. For example, in the case where the service screening label is delicacy, the label may be used to screen out service search results related to delicacy, and in the case where the service screening label is a scenic spot, the label may be used to screen out service search results related to the scenic spot.

Different geographical locations may have different location features, and the geographical location features can reflect highlight information of the geographical locations, and the highlight information may be, for example, unique cultural heritage, unique location characteristics, and distinctive city services. For example, in the case where the geographical location A has rich cultural heritage (for example, as the birthplace of culture A) and includes a large number of former residences of historical celebrities, the geographical features may include features related to culture A and features related to the former residences of the historical celebrities; in the case where the geographical location B has a large number of universities, the geographical features may include features related to the universities; and in the case where the geographical location C has a vast landform and is suitable for self-driving travel, the geographical features may include features related to self-driving travel.

Different geographical locations have different location features, and different service screening labels may be determined for the geographical locations according to the location features. For example, in the case where the geographical feature of the geographical location A includes a feature related to the culture A, the service screening label determined for the geographical location A may include a feature label for screening out a service search result related to the culture A; in the case where the location feature of the geographical location B includes a feature related to the university, the service screening label determined for the geographical location B may include a university label; in the case where the geographical location C includes a feature related to self-driving travel, the service screening label determined for the geographical location C may include a self-driving travel label, a car rental label, etc. In the case where the geographical location D includes a feature related to a local delicacy A, the service screening label determined for the geographical location D may include a local delicacy A label.

During specific implementation, in response to receiving the search information, whether the search information indicates searching for the travel service related to the geographical location may be determined. If not, search results related to the search information may be directly acquired and displayed. If so, the location feature of the geographical location may be determined, and at least one distinctive service screening label related to the location feature is determined according to the location feature. For example, the university label may be generated. At the same time, at least one conventional service screening label may be generated according to a service with a relatively high frequency of use in the travel service, for example, a delicacy label, a hotel label, a scenic spot label, a surrounding label, etc. may be generated. After that, the distinctive service screening label and the conventional service screening label may be used together as the plurality of service screening labels related to the travel service that are acquired.

Exemplarily, in the case where the geographical location indicated by the search information 1 is the location A and the geographical location indicated by the search information 2 is the location B, when searching by using the search information 1, the conventional service screening labels 1˜3 in white color and the distinctive service screening label 4 may be generated for the search information 1; and when searching by using the search information 2, the conventional service screening labels 1˜3 in white color and the distinctive service screening label 5 may be generated for the search information 2.

In this way, during each search, a unique service screening label related to the geographical location may be generated according to the location feature of the geographical location indicated by the search information. Therefore, when the geographical locations indicated by the search information are different, the generated service screening labels will also be different, that is, the dynamic generation of the service screening label is realized during each search.

S102, displaying the plurality of service screening labels and service search results under a currently selected service screening label.

Here, the currently selected service screening label may be a service screening label actively selected by the user after displaying the plurality of service screening labels in the search result, or may be a service screening label matched with the travel service indicated by the search information (for example, if the search information is scenic spots in XX city, the currently selected service screening label may be a delicacy label), or may be a preset service screening label or a distinctive service screening label corresponding to the geographical location. The service search results under the service screening label are search results with attributes corresponding to the service screening label.

During specific implementation, after acquiring the plurality of service screening labels, the plurality of service screening labels may be displayed in the search result page. At the same time, the service search results matched with the currently selected service screening label may be determined from all of the acquired service search results matched with the search information, and the service search results under the currently selected service screening label are displayed. The currently selected service screening label may also be highlighted, and the service search results may be displayed below the currently selected service screening label.

Exemplarily, in the case where the plurality of service screening labels include a delicacy label, a hotel label, a car rental label and a self-driving travel label, and the currently selected label is the self-driving travel label, the service search results related to the self-driving travel label may be determined from all of the service search results matched with the search information and displayed under the self-driving travel label.

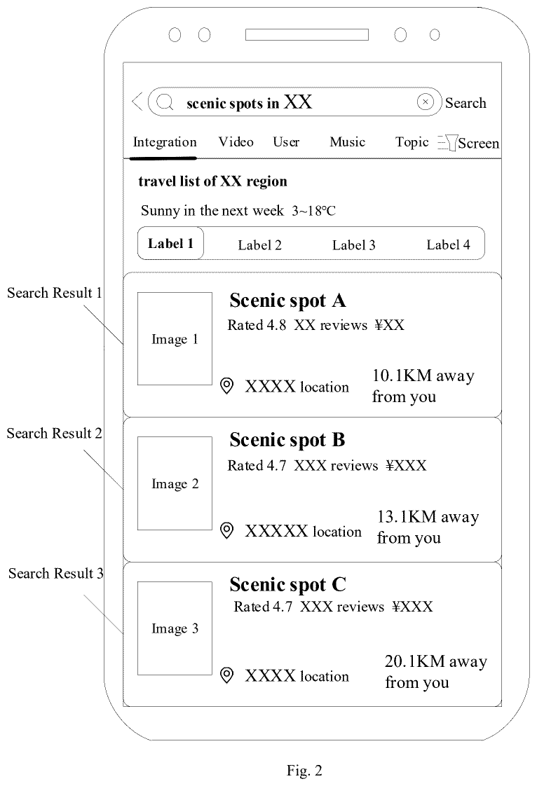

As shown in FIG. 2, which is a schematic diagram of a search result page provided by an embodiment of the present disclosure, where the search information is scenic spots in XX, the plurality of service screening labels include three conventional service screening labels (namely, labels 1˜3) and one distinctive service screening label (namely, label 4), the currently selected service screening label is label 1, and the search result page displays service search results under label 1 (such as service search results 1˜3 in FIG. 2). Label 1 may be a scenic spot label, label 2 may be a hotel label, label 3 may be a delicacy label, and label 4 may be a university label.

In an embodiment, in order to further improve the screening precision of the search results, the service screening labels may further include a first-level service screening label and a second-level service screening label associated with the first-level service screening label, where the first-level service screening label may include a service screening label dynamically determined according to a location feature of a geographical location, and the second-level service screening label may be determined according to dimensional attributes of service search results under the first-level service screening label in different dimensions. Here, the different dimensions may be determined according to common information of the service search results under the first-level service screening label, or may be preset dimensions. Exemplarily, the different dimensions may include, for example, a popularity dimension, a historical dimension, a type dimension, a landmark dimension, etc. The dimensional attribute may be dimensional information of the service search result in the corresponding dimension, for example, the number of visitors in the popularity dimension, the historical feature in the historical dimension, the result type in the type dimension, the landmark information in the landmark dimension, etc.

Different first-level service screening labels may correspond to different second-level service screening labels, the number of the second-level service screening labels corresponding to different first-level service screening labels may be different, and the second-level service screening labels corresponding to one first-level service screening label may be determined according to the service search results under the first-level service screening label. The second-level service screening label may be used to further screen the service search results under the first-level service screening label, which corresponds to a finer screening granularity.

Specifically, in the case where the service screening labels include the first-level service screening label and the second-level service screening label associated with the first-level service screening label, the step “acquiring a plurality of service screening labels” in S101 may be implemented as follows:
acquiring a plurality of first-level service screening labels related to the travel service and a plurality of second-level service screening labels under each of the plurality of first-level service screening labels, where the first-level service screening label is dynamically determined according to the location feature of the geographical location, and the second-level service screening label is used to screen the service search results under the first-level service screening label, and the second-level service screening label is determined according to the dimensional attributes of the service search results under the first-level service screening label in different dimensions.

During specific implementation, at least one distinctive first-level service screening label related to the location feature may be determined according to the location feature. For example, a self-driving travel label may be generated. At the same time, at least one conventional first-level service screening label may be generated according to the service with a relatively high frequency of use in the travel service, for example, a delicacy label and a hotel label may be generated. At the same time, for each of the first-level service screening labels, the second-level service screening labels under the first-level service screening label may be determined according to the dimensional attributes of the service search results under the first-level service screening label in different dimensions. For example, in the case where the dimensional attribute of the service search result under the first-level service screening label in the historical dimension is the former residence of the historical celebrity, the former residence of the historical celebrity may be used as one second-level service screening label associated with the first-level service screening label; and in the case where the service search results under the first-level service screening label have different numbers of browsing times in the popularity dimension, respectively, the popularity may be used as one second-level service screening label associated with the first-level service screening label; and in the case where there is a dimensional attribute of a service search result under the first-level service screening label in the popularity dimension being the landmark A, the landmark A may be used as one second-level service screening label associated with the first-level service screening label.

After acquiring the plurality of first-level service screening labels related to the travel service and the plurality of second-level service screening labels under each of the plurality of first-level service screening labels, the above S102 may also be implemented as follows:
displaying the plurality of first-level service screening labels and target second-level service screening labels under a currently selected first-level service screening label; and
displaying service search results under a currently selected target second-level service screening label.

Here, the target second-level service screening label is each of the second-level service screening labels under the currently selected first-level service screening label; and the currently selected target second-level service screening label may be a second-level service screening label that is preset, or may be a second-level service screening label selected by the user.

Exemplarily, the plurality of first-level service screening labels may be displayed in the search result page, and at the same time, the currently selected first-level service screening label may be determined, and the target second-level service screening labels under the currently selected first-level service screening label may be displayed. Moreover, the currently selected target second-level service screening label may also be determined, and service search results with the dimensional attribute corresponding to the currently selected target second-level service screening label may be screened out from the service search results under the first-level service screening label, and these service search results are used as the service search results under the currently selected target second-level service screening label and displayed below the target second-level service screening label.

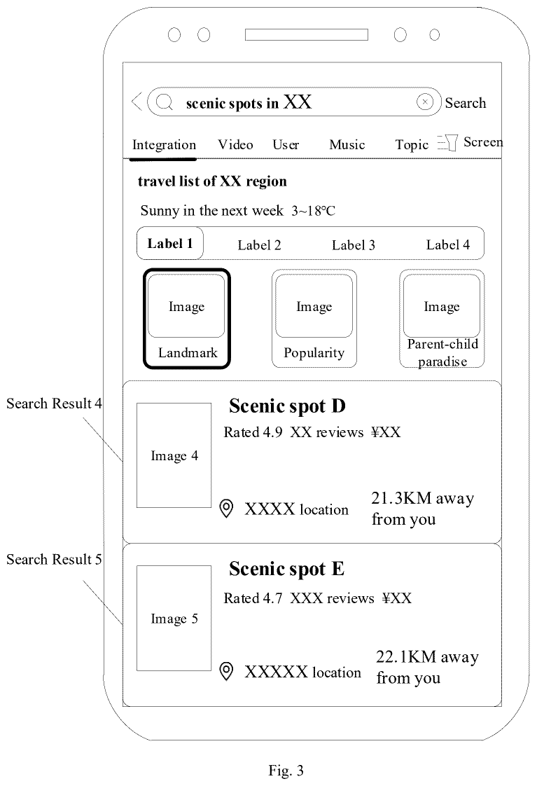

As shown in FIG. 3, which is a schematic diagram of displaying a second-level service screening label provided by an embodiment of the present disclosure, where the search information is scenic spots in XX, the plurality of first-level service screening labels include three conventional service screening labels (namely, labels 1˜3) and one distinctive service screening label (namely, label 4), the currently selected service screening label is label 1, and a plurality of target second-level service screening labels corresponding to label 1 (such as a landmark label, a popularity label, and a parent-child paradise label in FIG. 3 are displayed under the label 1). The currently selected target second-level service screening label is the landmark label, and a plurality of search results (such as search result 4 and search result 5 in FIG. 3) under label 1 are displayed below the landmark label.

In addition, after displaying the service search results under the currently selected target second-level service screening label, the service search results under other triggered target second-level service screening labels may also be updated and displayed in response to an operation of triggering the other target second-level service screening labels.

In this way, by setting the first-level service screening label and the second-level service screening label, finer-grained screening for each first-level service screening label can also be realized, which is conducive to improving the screening speed and precision and realizing efficient screening.

In an embodiment, in order to improve the richness of the recommendation information and facilitate the user to obtain more information to help the user to make decisions, in addition to directly displaying the service search results, the recommendation reasons of the service search results may also be displayed. Specifically, the above S103 may also be implemented as follows:
displaying the service search results under the currently selected service screening label and displaying, at a preset position of a display region of each of the service search results, a recommendation reason corresponding to the service search result.

Exemplarily, a display region of a service search result is a page region for displaying the service search result in the search result page, and the preset position may be set according to experience, which is not specifically limited in the embodiment of the present disclosure. For example, the preset position may be at the bottom of the display region and located below the result content corresponding to the search result, or the preset position may be at the lower left corner or the lower right corner of the display region, etc.

For example, in FIG. 3, the search result 2, the search result 4 and the search result 5 have corresponding recommendation reasons (namely, recommendation reason 1, recommendation reason 2 and recommendation reason 3), respectively, and the recommendation reason of each of the service search results is displayed below the result content corresponding to the service search result and at the bottom of the display region of the service search result.

In this way, by displaying the recommendation reasons of the service search results, the user can be helped to have a preliminary understanding of the service search results according to the recommendation reasons, thereby helping the user to make decisions on using the service search results better.

In an embodiment, the step “displaying the service search results under the currently selected service screening label”in S102 may also be implemented as follows:
S1, displaying first service search results under a currently selected first service screening label.

Here, the first service screening label is the currently selected service screening label, and the first service search result is a service search result with an attribute corresponding to the first service screening label.

Optionally, when displaying the first service search results under the currently selected first service screening label, the recommendation reasons corresponding to the first service search results may also be displayed at the preset positions of the display regions of the first service search results.
S2, acquiring consumption data of the first service search results corresponding to the first service screening label.

Here, the consumption data may be data acquired with authorization, which is used to index result consumption information related to the first service search result. Specifically, the consumption data may include data such as the number of browsing times of the first service search result, the browsing duration, whether it is favorited, etc.

During specific implementation, after displaying the first service search results, the consumption data corresponding to the first service search results may be acquired.
S3, switching to display second service search results under a second service screening label in response to the second service screening label being selected, where a display priority of each of the second service search results is associated with the consumption data of the first service search results.

Here, the second service screening label may be any service screening label among the plurality of service screening labels, except for the currently selected first service screening label. The second service search result may be a service search result with an attribute corresponding to the second service screening label.

During specific implementation, after displaying the first service search results, in response to a selection operation of the user on the second service screening label in the search result page, the second service search results under the second service screening label may be acquired, the highlighting display of the first service screening label is cancelled and the second service screening label is highlighted for display; and at the same time, the second service search results under the second service screening label may be updated and displayed in the search result page.

The second service search results have different display priorities, and the display priorities of the second service search results may be determined according to the consumption data of the first service search results. Exemplarily, the consumed first service search results with the browsing duration exceeding a preset duration or the consumed first service search results with the number of the browsing times exceeding a preset number of times or the consumed first service search results being favorited may be determined according to the consumption data of the first service search results. Then, the first results associated with at least one consumed first service search result and the second results not associated with any consumed first service search result may be screened out from the second service search results. The association between the second service search result and the consumed first service search result may be an association in location (for example, whether they are located in the same region, whether they are located in the same street, whether they are located in a business district, etc.). For each of the first results, the first display priority of the first result may be determined according to the number of the target first service search results associated with the first result; and for each of the second results, the second display priority of the second result may be determined according to the object recommendation index of the second result. The first display priority is higher than the second display priority. After that, the second service search results may be displayed according to the first display priority and the second display priority.

Optionally, when displaying the second service search results, the recommendation reasons corresponding to the second service search results may also be displayed at the preset positions of the display regions of the second service search results.

In an embodiment, the above S3 may be implemented as follows:
S3-1, acquiring a distance between a position corresponding to each of the second service search results and a position corresponding to a target first service search result in response to the second service screening label being selected, where the target first service search result is determined according to a browsing duration and a number of browsing times indicated by the consumption data of the first service search results.

Here, the target first service search result may be a first service search result whose browsing duration indicated by the consumption data exceeds the preset duration and whose number of browsing times exceeds the preset number of times, and there may be one or more target first service search results. The position corresponding to the service search result may be understood as the coordinate position of the service provider corresponding to the service search result. For example, in the case where the service search result is a hotel, the position corresponding to the service search result is the position of the hotel; in the case where the service search result is a restaurant, the position corresponding to the service search result is the position of the restaurant; and in the case where the service search result is a scenic spot, the position corresponding to the service search result is the position of the scenic spot.

During specific implementation, for each of the second service search results, the distance between the second service search result and each of the target first service search results may be determined according to the position corresponding to the second service search result and the position corresponding to the target first service search result.
S3-2, switching to display the second service search results under the second service screening label and displaying, in the display region of each of the second service search results, the distance corresponding to the each of the second service search results, where the display priority is determined according to the distance and a rating of the each of the second service search results.

Exemplarily, for each of the second service search results, an average distance corresponding to the each of the second service search results may be determined according to the distances between the each of the second service search results and each of the target first service search results. Then, the second service search results whose average distance is less than a preset distance may be used as the third results, and the second service search results whose average distance is greater than or equal to the preset distance may be used as the fourth results. For each of the third results, the display priority of the third result may be determined according to the average distance corresponding to the each of the third results in an order from small to large. At the same time, for each of the fourth results, the display priority of the fourth result may be determined according to the rating of the each of the fourth results in an order from high to low. The display priority of the fourth result is lower than the display priority of the third result. The final display priority corresponding to each of the second service search results is obtained according to the display priority of the third results and the display priority of the fourth results.

Alternatively, for each of the second service search results, an average distance corresponding to the each of the second service search results may be determined according to the distances between the each of the second service search results and each of the target first service search results. After that, the second service search results may be ranked according to the average distance corresponding to each of the second service search results in an order from low to high, to obtain the first ranking order of each of the second service search results. At the same time, the second service search results may be ranked according to the rating of each of the second service search results in an order from high to low, to obtain the second ranking order of each of the second service search results. For each of the second service search results, an average order value corresponding to the each of the second service search results may be determined according to the value of the first ranking order and the value of the second ranking order of the each of the second service search results. After that, the display priority of each of the second service search results may be determined according to the average order value corresponding to each of the second service search results. For example, the smaller the average order value is, the higher the display priority will be.

Alternatively, the consumption intention index of each of the target first service search results may also be determined according to the browsing duration and the number of browsing times of the target first service search results. The consumption intention index may be determined as the sum of the browsing duration and the number of browsing times. After that, the target first service search result with the highest intention consumption index may be determined according to the consumption intention indexes. After that, for each of the second service search results whose distance from the target first service search result with the highest intention consumption index is less than the preset distance, the first display priority of the second service search result may be determined according to the distance from the target first service search result with the highest intention consumption index in an order from low to high. At the same time, for each of the second service search results whose distance from the target first service search result with the highest intention consumption index is greater than the preset distance, the second display priority of the second service search result may be determined according to the rating in an order from high to low. The first display priority is higher than the second display priority. The final display priority of each of the second service search results is determined according to the first display priority and the second display priority.

Alternatively, a plurality of target first service search results whose consumption intention index is relatively higher and whose ranking order is less than the preset order may be screened out according to the consumption intention indexes. After that, according to the distance between each of the second service search results and each of the target first service search results with higher consumption intention index, a plurality of second service search results whose sum of distances is less than a preset sum of distances may be determined. Then, the first display priority of each of these second service search results may be determined according to the sum of distances in an order from low to high. At the same time, for a plurality of second service search results whose sum of distances is greater than or equal to the preset sum of distances, the second display priority of each of these second service search results may be determined according to the rating in an order from high to low. After that, the final display priority of each of the second service search results may be determined according to the first display priority and the second display priority.

After the second service search results are obtained, the display priority of each of the second search results may also be acquired. Then, it's switched to display the second service search results under the second service screening label in the search result page according to the display priority. Moreover, for each of the second service search results, the distance between the second service search result and each of the target first service search results may be displayed in the display region corresponding to the second service search result, or the distance between the second service search result and each of some of the target first service search results with the highest intention consumption index may be displayed in the display region corresponding to the second service search result. Each of the distances may be displayed at any preset position in the display region corresponding to the second service search result.

In this way, by displaying the distance between the second service search result and the target first service search result in the display region of the second service search result, it is convenient for the user to make an optimal decision according to the distance, which is conducive to improving the search experience of the user.

Optionally, before triggering the second service screening label, if there is consumption data of service search results under a plurality of other service screening labels, the target first service search results corresponding to the plurality of other service screening labels may be screened out according to the consumption data of the service search results under the plurality of other service screening labels, and then, the display priority of each of the second service search results may be determined according to the distance between the second service search result and each of the target first service search results corresponding to each of the plurality of other service screening labels. For example, the second service search results with smaller distances from the target first service search results corresponding to each of the plurality of other service screening labels may be preferentially displayed.

For another example, the user browses delicacy A and scenic spot A, and after triggering the hotel label, the hotels that have a distance from the position corresponding to the delicacy A within the preset distance and higher ratings may be preferentially displayed, and the hotels that have a distance from the scenic spot A within the preset distance and higher ratings may be preferentially displayed. At the same time, the actual distances between the recommended hotels and each of the delicacy A and the scenic spot A may also be displayed.

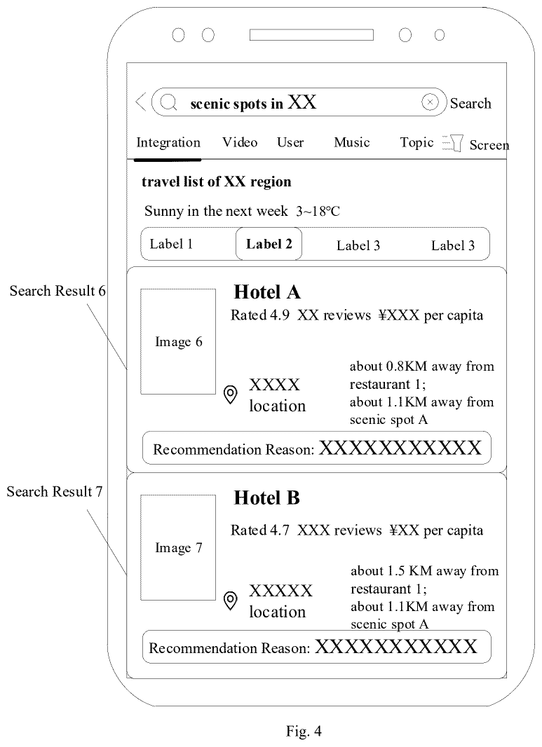

As shown in FIG. 4, which is a schematic diagram of switching to display second service search results provided by an embodiment of the present disclosure, where the target first service search results may be restaurant 1 and scenic spot A, the second service search results include search results 6 and 7, and the distances between the second service search results and each of the restaurant 1 and the scenic spot A are displayed in the display region corresponding to the second service search results. In FIG. 4, the distances between the search result 6 and each of the restaurant 1 and the scenic spot A are 0.8 kilometers (KM) and 1.1 KM, respectively, and the distances between the search result 7 and each of the restaurant 1 and the scenic spot A are 1.5 KM and 1.1 KM, respectively, and the second search result is a search result under the hotel label.

In an embodiment, the step “displaying the service search results under the currently selected service screening label”in S102 may also be implemented as follows:
displaying aggregated service information under the currently selected service screening label, where the aggregated service information includes a plurality of service recommendation sets, and each of the plurality of service recommendation sets includes a plurality of service search results from a plurality of service channels, and the plurality of service search results correspond to a same entity object.

Here, the entity object in the service search result is a subject for providing the service in the service search result. For example, in the case where the service search result is a delicacy result, the entity object may be a restaurant, a diner, etc. in the delicacy result. In the case where the service search result is a scenic spot result, the entity object may be a specific scenic spot in the scenic spot result. In the case where the service search result is a hotel result, the entity object may be a specific hotel in the hotel result.

The service channel is a channel for providing services corresponding to various entity objects, and different service channels have different recommendation manners and recommendation requirements.

During specific implementation, among the acquired plurality of service search results, the service search results corresponding to the same entity object may be located in the same service recommendation set, and the plurality of service recommendation sets composed of the plurality of service search results are used to form the aggregated service information.

During specific implementation, the service search results matched with the search information may be acquired from the plurality of service channels, and then the aggregated service information under each of the service screening labels may be determined according to the service search results under the each of the service screening labels. After that, while displaying the plurality of service screening labels, the aggregated service information under the currently selected service screening label may be displayed.

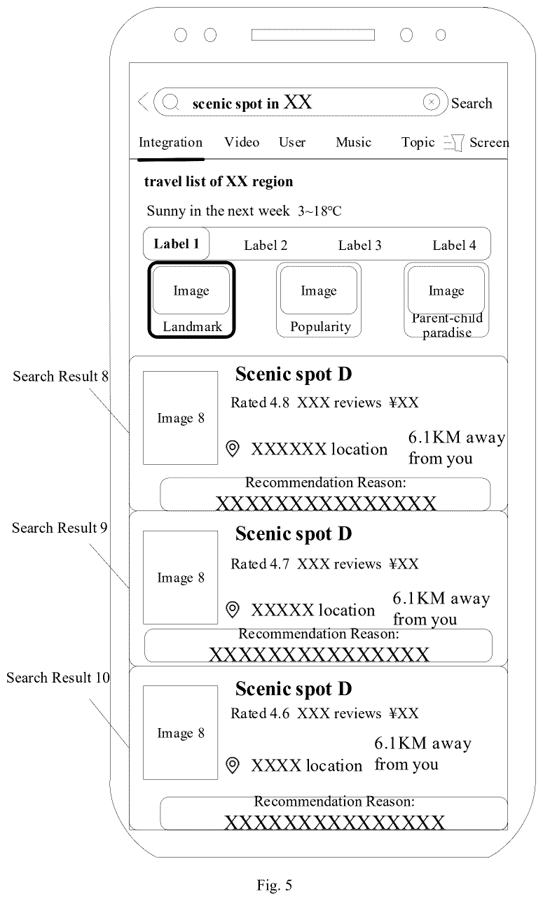

As shown in FIG. 5, which is a schematic diagram of another service search result provided by an embodiment of the present disclosure, where the search information is scenic spots in XX, the plurality of service screening labels include three conventional service screening labels (namely, labels 1˜3) and one distinctive service screening label (namely, label 4), the currently selected service screening label is label 1, and the search result page displays the service recommendation set 1 in the aggregated service information under label 1, where the service recommendation set 1 includes three service search results (namely, search results 8˜10), where search results 8˜10 correspond to the same entity object, namely, scenic spot D; and search results 8˜10 are from different service channels. The recommendation reason corresponding to each of the service search results is also displayed at the preset position of the display region of the each of the service search results. The recommendation reasons of the service search results in the service recommendation set may be the same, that is, the recommendation reason provided by any service channel may be used; or the recommendation reasons of the service search results in the service recommendation set may be different, that is, the recommendation reason provided by the corresponding service channel of the service search result may be directly used. In FIG. 5, the recommendation reasons of the three service search results in the service recommendation set 1 are consistent.

In an embodiment, the step “displaying aggregated service information under the currently selected service screening label”may be implemented as follows:
displaying each of the plurality of service recommendation sets under the currently selected service screening label according to a first recommendation order of each of the plurality of service recommendation sets in the aggregated service information; and displaying the service search results in each of the plurality of service recommendation sets according to a second recommendation order of each of the service search results in each of the plurality of service recommendation sets.

The first recommendation order is determined according to an object recommendation index of the entity object corresponding to the service search results in each of the plurality of service recommendation sets; and the second recommendation order is determined according to a ranking weight of the corresponding service channel of each of the service search results and the object recommendation index of the entity object corresponding to each of the service search results.

Here, the object recommendation index may include an object rating of the entity object, an object popularity index of the entity object, a content volume of the entity object, etc. The service channels may have preset ranking weights, and different service channels have different ranking weights. The first recommendation order is used to indicate the display priority of each of the service recommendation sets, and the second recommendation order is used to indicate the display priority of each of the service search results in the service recommendation set.

Exemplarily, when acquiring the aggregated service information under each of the service screening labels, the first recommendation order of each of the service recommendation sets in the aggregated service information and the second recommendation order of each of the service search results in each of the service recommendation sets may also be acquired at the same time. After that, each of the service recommendation sets may be displayed under the currently selected service screening label according to the first recommendation order of each of the service recommendation sets in the aggregated service information; and for each of the service recommendation sets, the service search results may be displayed according to the second recommendation order of each of the service search results in the each of the service recommendation sets.

The first recommendation order of the service recommendation set in the aggregated service information may be determined as follows: determining the entity object and the object rating of each of the service recommendation sets in the aggregated service information, determining the average value of the object rating according to the object ratings of the entity object of the service recommendation set in the plurality of service channels, and determining the first recommendation order of each of the service recommendation sets according to the average value of the object rating in an order from high to low. Alternatively, the average value of the popularity index may be determined according to the object popularity indexes of the entity object of the service recommendation set in the plurality of service channels, and then the first recommendation order of each of the service recommendation sets may be determined according to the average value of the popularity index in an order from high to low. Alternatively, the average recommendation coefficient corresponding to each of the service recommendation sets may be determined according to the average value of the popularity index and the average value of the object rating of the entity object of the service recommendation set, and then the first recommendation order of each of the service recommendation sets may be determined according to the average recommendation coefficient in an order from high to low.

The second recommendation order of the service search results in each of the service recommendation sets may be determined according to the following steps: for each of the service search results, determining the object rating of the service search result in the target service channel to which the service search result belongs, weighting the object rating of the service search result in the target service channel according to the ranking weight of the target service channel, to obtain a weighted value corresponding to the service search result. The second recommendation order of the service search result is determined according to the weighted value corresponding to the service search result in an order from high to low.

It can be understood by those of ordinary skill in the art that in the above method of specific implementation, the writing sequence of the steps does not mean a strict execution sequence nor constitutes any limitation to the implementation process, and the specific execution sequence of the steps should be determined according to the functions and possible internal logic thereof.

Based on the same inventive concept, an embodiment of the present disclosure further provides a search apparatus corresponding to the search method. Since the principle of solving the problem by the apparatus in the embodiment of the present disclosure is similar to the search method in the above embodiment of the present disclosure, the implementation of the apparatus can refer to the implementation of the method, and the repetitions will not be repeated.

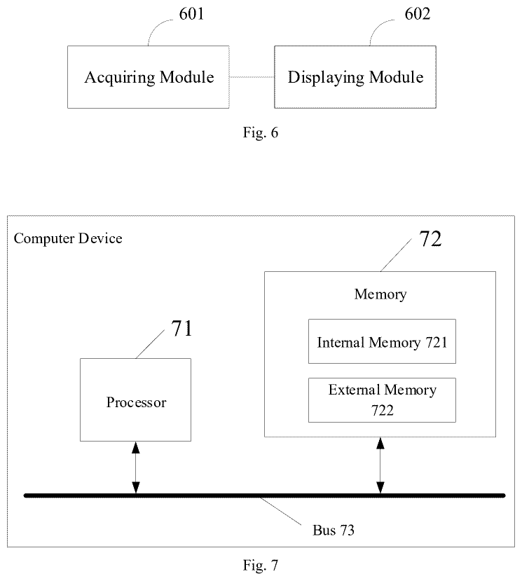

As shown in FIG. 6, which is a schematic diagram of a search apparatus provided by an embodiment of the present disclosure, the search apparatus includes:
an acquiring module 601, configured to acquire a plurality of service screening labels related to a travel service in response to receiving search information which indicates searching for the travel service related to a geographical location, where the service screening label is dynamically determined according to a location feature of the geographical location, and different service screening labels are determined for different geographical locations; and
a displaying module 602, configured to display the plurality of service screening labels and service search results under a currently selected service screening label.

In a possible implementation, the displaying module 602, when displaying the service search results under the currently selected service screening label, is configured to:
display first service search results under a currently selected first service screening label;
acquire consumption data of the first service search results corresponding to the first service screening label; and
switch to display second service search results under a second service screening label in response to the second service screening label being selected, where a display priority of each of the second service search results is associated with the consumption data of the first service search results.

In a possible implementation, the displaying module 602, when switching to display the second service search results under the second service screening label in response to the second service screening label being selected, is configured to:
acquire a distance between a position corresponding to each of the second service search results and a position corresponding to a target first service search result in response to the second service screening label being selected, where the target first service search result is determined according to a browsing duration and a number of browsing times indicated by the consumption data of the first service search results; and
switch to display the second service search results under the second service screening label and display, in a display region of each of the second service search results, the distance corresponding to the each of the second service search results, where the display priority is determined according to the distance and a rating of the each of the second service search results.

In a possible implementation, the displaying module 602, when displaying the service search results under the currently selected service screening label, is configured to:
display aggregated service information under the currently selected service screening label, where the aggregated service information includes a plurality of service recommendation sets, and each of the plurality of service recommendation sets includes a plurality of service search results from a plurality of service channels, and the plurality of service search results correspond to a same entity object.

In a possible implementation, the service screening labels include a first-level service screening label and a second-level service screening label associated with the first-level service screening label;
the acquiring module 601, when acquiring the plurality of service screening labels related to the travel service, is configured to:
acquire a plurality of first-level service screening labels related to the travel service and a plurality of second-level service screening labels under each of the plurality of first-level service screening labels, where the first-level service screening label is dynamically determined according to the location feature of the geographical location, and the second-level service screening label is used to screen the service search results under the first-level service screening label, and the second-level service screening label is determined according to dimensional attributes of the service search results under the first-level service screening label in different dimensions; and
the displaying module 602, when displaying the plurality of service screening labels and the service search results under the currently selected service screening label, is configured to:
display the plurality of first-level service screening labels and target second-level service screening labels under a currently selected first-level service screening label; and
display service search results under a currently selected target second-level service screening label.

In a possible implementation, the displaying module 602, when displaying the aggregated service information under the currently selected service screening label, is configured to:
display each of the plurality of service recommendation sets under the currently selected service screening label according to a first recommendation order of each of the plurality of service recommendation sets in the aggregated service information; and displaying the service search results in each of the plurality of service recommendation sets according to a second recommendation order of each of the service search results in the each of the plurality of service recommendation sets;
where the first recommendation order is determined according to an object recommendation index of the entity object corresponding to the service search results in each of the plurality of service recommendation sets; and the second recommendation order is determined according to a ranking weight of the corresponding service channel of each of the service search results and the object recommendation index of the entity object corresponding to the each of the service search results.

In a possible implementation, the displaying module 602, when displaying the service search results under the currently selected service screening label, is configured to:
display the service search results under the currently selected service screening label and displaying, at a preset position of a display region of each of the service search results, a recommendation reason corresponding to the each of the service search results.

For the description of the processing flow of each module in the apparatus and the interaction flow between the modules, reference may be made to the related description in the above method embodiments, and the details will not be described here again.

Based on the same technical concept, an embodiment of the present disclosure further provides a computer device. Referring to FIG. 7, which is a schematic diagram of the structure of a computer device provided by an embodiment of the present disclosure, the computer device includes:
a processor 71, a memory 72 and a bus 73. The memory 72 stores machine-readable instructions executable by the processor 71, and the processor 71 is configured to execute the machine-readable instructions stored in the memory 72. When the machine-readable instructions are executed by the processor 71, the processor 71 performs the following steps: S101, acquiring a plurality of service screening labels related to a travel service in response to receiving search information which indicates searching for the travel service related to a geographical location, where the service screening label is dynamically determined according to a location feature of the geographical location, and different service screening labels are determined for different geographical locations; and S102, displaying the plurality of service screening labels and service search results under a currently selected service screening label.

The memory 72 includes an internal memory 721 and an external memory 722. The internal memory 721 is also referred to as an internal storage, which is used to temporarily store the operation data in the processor 71 and the data exchanged with the external memory 722 such as a hard disk. The processor 71 exchanges data with the external memory 722 through the internal memory 721. When the computer device is running, the processor 71 communicates with the memory 72 through the bus 73, so that the processor 71 executes the execution instructions mentioned in the above method embodiments.

An embodiment of the present disclosure further provides a computer-readable storage medium storing a computer program, where the computer program, when executed by a processor, performs the steps of the search method according to the above method embodiments. The storage medium may be a volatile or non-volatile computer-readable storage medium.

A computer program product of the search method provided by an embodiment of the present disclosure includes a computer-readable storage medium storing program codes, where instructions included in the program codes may be used to perform the steps of the search method according to the above method embodiments, and reference may be made to the above method embodiments for details, which will not be repeated here.

The computer program product may be implemented in hardware, software or a combination thereof. In an optional embodiment, the computer program product is embodied as a computer storage medium, and in another optional embodiment, the computer program product is embodied as a software product, such as a software development kit (SDK), etc.

It can be clearly understood by those skilled in the art that for the convenience and simplicity of description, for the specific working process of the above-described apparatus, reference may be made to the corresponding process in the foregoing method embodiments, which will not be repeated here. In the several embodiments provided in the present disclosure, it should be understood that the disclosed apparatus and method may be implemented in other manners. The above-described apparatus embodiments are merely illustrative. For example, the division of the units is only a logical function division, and there may be other division manners in actual implementation. For another example, multiple units or components may be combined, or some features may be ignored, or not executed. In addition, the mutual coupling or direct coupling or communication connection shown or discussed may be through some communication interfaces, and the indirect coupling or communication connection of the apparatus or unit may be electrical, mechanical or other forms.

The unit described as a separate component may or may not be physically separated, and the component displayed as a unit may or may not be a physical unit, that is, it may be located in one place, or may be distributed on multiple network units. Some or all of the units may be selected according to actual needs to achieve the objectives of the solutions of the embodiments.

In addition, the functional units in the embodiments of the present disclosure may be integrated into one processing unit, or each unit may exist physically alone, or two or more units may be integrated into one unit.

If the functions are implemented in the form of software functional units and sold or used as independent products, they can be stored in a non-volatile computer-readable storage medium that can be executed by a processor. Based on such understanding, the technical solutions of the present disclosure, or the part thereof that contributes to the prior art, or the part of the technical solutions may be embodied in the form of a software product, which is stored in a storage medium and includes several instructions for causing a computer device (which may be a personal computer, a server, or a network device, etc.) to perform all or part of the steps of the methods described in the various embodiments of the present disclosure. The aforementioned storage medium includes: various media that can store program codes, such as a USB flash drive, a mobile hard disk, a read-only memory (ROM), a random-access memory (RAM), a magnetic disk, or an optical disk.

If the technical solutions of the present disclosure relate to personal information, a product applying the technical solutions of the present disclosure has clearly informed the personal information processing rules and obtained personal consent before processing the personal information. If the technical solutions of the present disclosure relate to sensitive personal information, a product applying the technical solutions of the present disclosure has obtained personal separate consent and met the requirement of “express consent” before processing the sensitive personal information. For example, at a personal information collection apparatus such as a camera, a clear and prominent identification is set to inform that the personal information collection scope has been entered and personal information will be collected. If an individual voluntarily enters the collection scope, it is deemed that the individual consents to the collection of personal information; or in the case where the personal information processing rules are informed by using a prominent identification/information on a personal information processing apparatus, personal authorization is obtained by means of pop-up information or personal uploading of personal information. The personal information processing rules may include information such as a personal information processor, a purpose of personal information processing, a processing manner, and a type of personal information to be processed.

Finally, it should be noted that the above embodiments are only specific implementations of the present disclosure, which are used to illustrate the technical solutions of the present disclosure, but not to limit the technical solutions of the present disclosure. The protection scope of the present disclosure is not limited thereto. Although the present disclosure has been described in detail with reference to the foregoing embodiments, those of ordinary skill in the art should understand that any person skilled in the art can still modify the technical solutions described in the foregoing embodiments or can easily conceive of changes, or equivalently replace some technical features thereof within the technical scope disclosed in the present disclosure; and these modifications, changes or replacements do not make the essence of the corresponding technical solutions depart from the spirit and scope of the technical solutions of the embodiments of the present disclosure, and all of them should be covered within the protection scope of the present disclosure. Therefore, the protection scope of the present disclosure should be subject to the protection scope of the claims.

1. A search method, comprising:
acquiring a plurality of service screening labels related to a travel service in response to receiving search information which indicates searching for the travel service related to a geographical location, wherein the service screening label is dynamically determined according to a location feature of the geographical location, and different service screening labels are determined for different geographical locations; and
displaying the plurality of service screening labels and service search results under a currently selected service screening label.

2. The method according to claim 1, wherein displaying the service search results under the currently selected service screening label comprises:
displaying first service search results under a currently selected first service screening label;
acquiring consumption data of the first service search results corresponding to the first service screening label; and
switching to display second service search results under a second service screening label in response to the second service screening label being selected, wherein a display priority of each of the second service search results is associated with the consumption data of the first service search results.

3. The method according to claim 2, wherein switching to display the second service search results under the second service screening label in response to the second service screening label being selected comprises:
acquiring a distance between a position corresponding to each of the second service search results and a position corresponding to a target first service search result in response to the second service screening label being selected, wherein the target first service search result is determined according to a browsing duration and a number of browsing times indicated by the consumption data of the first service search results; and
switching to display the second service search results under the second service screening label and displaying, in a display region of each of the second service search results, the distance corresponding to the each of the second service search results, wherein the display priority is determined according to the distance and a rating of the each of the second service search results.

4. The method according to claim 1, wherein displaying the service search results under the currently selected service screening label comprises:
displaying aggregated service information under the currently selected service screening label, wherein the aggregated service information comprises a plurality of service recommendation sets, and each of the plurality of service recommendation sets comprises a plurality of service search results which are from a plurality of service channels and correspond to a same entity object.

5. The method according to claim 1, wherein the service screening label comprises a first-level service screening label and a second-level service screening label associated with the first-level service screening label;
wherein acquiring the plurality of service screening labels related to the travel service comprises:
acquiring a plurality of first-level service screening labels related to the travel service and a plurality of second-level service screening labels under each of the plurality of first-level service screening labels, wherein the first-level service screening label is dynamically determined according to the location feature of the geographical location, and the second-level service screening label is used to screen service search results under the first-level service screening label, and the second-level service screening label is determined according to dimensional attributes of the service search results under the first-level service screening label in different dimensions; and
wherein displaying the plurality of service screening labels and the service search results under the currently selected service screening label comprises:
displaying the plurality of first-level service screening labels and target second-level service screening labels under a currently selected first-level service screening label; and
displaying service search results under a currently selected target second-level service screening label.

6. The method according to claim 4, wherein displaying the aggregated service information under the currently selected service screening label comprises:
displaying each of the plurality of service recommendation sets under the currently selected service screening label according to a first recommendation order of each of the plurality of service recommendation sets in the aggregated service information; and displaying the service search results in each of the plurality of service recommendation sets according to a second recommendation order of each of the service search results in the each of the plurality of service recommendation sets,
wherein the first recommendation order is determined according to an object recommendation index of the entity object corresponding to the service search results in the each of the plurality of service recommendation sets; and the second recommendation order is determined according to a ranking weight of the corresponding service channel of each of the service search results and the object recommendation index of the entity object corresponding to the each of the service search results.

7. The method according to claim 1, wherein displaying the service search results under the currently selected service screening label comprises:
displaying the service search results under the currently selected service screening label and displaying, at a preset position in a display region of each of the service search results, a recommendation reason corresponding to the each of the service search result.

8. (canceled)

9. A computer device, comprising: a processor and a memory, wherein the memory stores machine-readable instructions executable by the processor, the processor is configured to execute the machine-readable instructions stored in the memory, and the machine-readable instructions, when executed by the processor, are configured to cause the processor to perform steps of a search method, comprising:
acquiring a plurality of service screening labels related to a travel service in response to receiving search information which indicates searching for the travel service related to a geographical location, wherein the service screening label is dynamically determined according to a location feature of the geographical location, and different service screening labels are determined for different geographical locations; and
displaying the plurality of service screening labels and service search results under a currently selected service screening label.

10. A computer-readable storage medium, wherein the computer-readable storage medium stores a computer program, and the computer program, when run by a computer device, is configured to cause the computer device to perform steps of a search method comprising:
acquiring a plurality of service screening labels related to a travel service in response to receiving search information which indicates searching for the travel service related to a geographical location, wherein the service screening label is dynamically determined according to a location feature of the geographical location, and different service screening labels are determined for different geographical locations; and
displaying the plurality of service screening labels and service search results under a currently selected service screening label.

11. The computer device according to claim 9, wherein in the search method,
displaying the service search results under the currently selected service screening label comprises:
displaying first service search results under a currently selected first service screening label;
acquiring consumption data of the first service search results corresponding to the first service screening label; and
switching to display second service search results under a second service screening label in response to the second service screening label being selected, wherein a display priority of each of the second service search results is associated with the consumption data of the first service search results.

12. The computer device according to claim 11, wherein in the search method,
switching to display the second service search results under the second service screening label in response to the second service screening label being selected comprises:
acquiring a distance between a position corresponding to each of the second service search results and a position corresponding to a target first service search result in response to the second service screening label being selected, wherein the target first service search result is determined according to a browsing duration and a number of browsing times indicated by the consumption data of the first service search results; and
switching to display the second service search results under the second service screening label and displaying, in a display region of each of the second service search results, the distance corresponding to the each of the second service search results, wherein the display priority is determined according to the distance and a rating of the each of the second service search results.

13. The computer device according to claim 9, wherein in the search method,
displaying the service search results under the currently selected service screening label comprises:
displaying aggregated service information under the currently selected service screening label, wherein the aggregated service information comprises a plurality of service recommendation sets, and each of the plurality of service recommendation sets comprises a plurality of service search results which are from a plurality of service channels and correspond to a same entity object.

14. The computer device according to claim 9, wherein in the search method,
the service screening label comprises a first-level service screening label and a second-level service screening label associated with the first-level service screening label;
wherein acquiring the plurality of service screening labels related to the travel service comprises:
acquiring a plurality of first-level service screening labels related to the travel service and a plurality of second-level service screening labels under each of the plurality of first-level service screening labels, wherein the first-level service screening label is dynamically determined according to the location feature of the geographical location, and the second-level service screening label is used to screen service search results under the first-level service screening label, and the second-level service screening label is determined according to dimensional attributes of the service search results under the first-level service screening label in different dimensions; and
wherein displaying the plurality of service screening labels and the service search results under the currently selected service screening label comprises:
displaying the plurality of first-level service screening labels and target second-level service screening labels under a currently selected first-level service screening label; and
displaying service search results under a currently selected target second-level service screening label.

15. The computer device according to claim 13, wherein in the search method,
displaying the aggregated service information under the currently selected service screening label comprises:
displaying each of the plurality of service recommendation sets under the currently selected service screening label according to a first recommendation order of each of the plurality of service recommendation sets in the aggregated service information; and displaying, the service search results in each of the plurality of service recommendation sets according to a second recommendation order of each of the service search results in the each of the plurality of service recommendation sets;
wherein the first recommendation order is determined according to an object recommendation index of the entity object corresponding to the service search results in the each of the plurality of service recommendation sets; and the second recommendation order is determined according to a ranking weight of the corresponding service channel of each of the service search results and the object recommendation index of the entity object corresponding to the each of the service search results.

16. The computer device according to claim 9, wherein in the search method,
displaying the service search results under the currently selected service screening label comprises:
displaying the service search results under the currently selected service screening label and displaying, at a preset position in a display region of each of the service search results, a recommendation reason corresponding to the each of the service search result.

17. The storage medium according to claim 10, wherein in the search method,
displaying the service search results under the currently selected service screening label comprises:
displaying first service search results under a currently selected first service screening label;
acquiring consumption data of the first service search results corresponding to the first service screening label; and
switching to display second service search results under a second service screening label in response to the second service screening label being selected, wherein a display priority of each of the second service search results is associated with the consumption data of the first service search results.

18. The storage medium according to claim 17, wherein in the search method,
switching to display the second service search results under the second service screening label in response to the second service screening label being selected comprises:
acquiring a distance between a position corresponding to each of the second service search results and a position corresponding to a target first service search result in response to the second service screening label being selected, wherein the target first service search result is determined according to a browsing duration and a number of browsing times indicated by the consumption data of the first service search results; and
switching to display the second service search results under the second service screening label and displaying, in a display region of each of the second service search results, the distance corresponding to the each of the second service search results, wherein the display priority is determined according to the distance and a rating of the each of the second service search results.

19. The storage medium according to claim 10, wherein in the search method,
displaying the service search results under the currently selected service screening label comprises:
displaying aggregated service information under the currently selected service screening label, wherein the aggregated service information comprises a plurality of service recommendation sets, and each of the plurality of service recommendation sets comprises a plurality of service search results which are from a plurality of service channels and correspond to a same entity object.

20. The storage medium according to claim 10, wherein in the search method,
the service screening label comprises a first-level service screening label and a second-level service screening label associated with the first-level service screening label;
wherein acquiring the plurality of service screening labels related to the travel service comprises:
acquiring a plurality of first-level service screening labels related to the travel service and a plurality of second-level service screening labels under each of the plurality of first-level service screening labels, wherein the first-level service screening label is dynamically determined according to the location feature of the geographical location, and the second-level service screening label is used to screen service search results under the first-level service screening label, and the second-level service screening label is determined according to dimensional attributes of the service search results under the first-level service screening label in different dimensions; and
wherein displaying the plurality of service screening labels and the service search results under the currently selected service screening label comprises:
displaying the plurality of first-level service screening labels and target second-level service screening labels under a currently selected first-level service screening label; and
displaying service search results under a currently selected target second-level service screening label.

21. The storage medium according to claim 19, wherein in the search method,
displaying the aggregated service information under the currently selected service screening label comprises:
displaying each of the plurality of service recommendation sets under the currently selected service screening label according to a first recommendation order of each of the plurality of service recommendation sets in the aggregated service information; and displaying, the service search results in each of the plurality of service recommendation sets according to a second recommendation order of each of the service search results in the each of the plurality of service recommendation sets;
wherein the first recommendation order is determined according to an object recommendation index of the entity object corresponding to the service search results in the each of the plurality of service recommendation sets; and the second recommendation order is determined according to a ranking weight of the corresponding service channel of each of the service search results and the object recommendation index of the entity object corresponding to the each of the service search results.
